(19) United States
(12) Patent Application Publication
(10) Pub. No.: US 2013/0328366 A1
(43) Pub. Date: Dec. 12, 2013

(54) AIRCRAFT SEATING ARRANGEMENT ACCOMMODATING HIGH-PERCENTILE HIP WIDTHS

(71) Applicant: B/E Aerospace, Inc., Wellington, FL (US)

(72) Inventor: R. Klaus Brauer, Seattle, WA (US)

(21) Appl. No.: 13/912,627

(22) Filed: Jun. 7, 2013

Related U.S. Application Data
(60) Provisional application No. 61/656,609, filed on Jun. 7, 2012.

(51) Int. Cl. B64D 11/06

(52) U.S. Cl. CPC B64D 11/06
USPC 297/232

(57) ABSTRACT

An aircraft seating arrangement for accommodating high-percentile hip widths including a seating unit including a plurality of adjacent, side-by-side seats and a plurality of armrests including end armrests positioned at opposing ends of the seating unit and middle armrests positioned between adjacent seats, wherein the end armrests are narrower than the middle armrests to maximize available hip space.

### CROSS-REFERENCE TO RELATED APPLICATION

This application claims priority to U.S. Provisional Application No. 61/656,609 filed Jun. 7, 2012, the entirety of which is incorporated by reference herein.

### TECHNICAL FIELD AND BACKGROUND OF THE INVENTION

The present invention relates generally to the field of aircraft passenger seating arrangements including groups of adjacent seats, and more particularly, to seating groups including adjacent seats separated by armrests, wherein the armrests located at the aisle and sidewall are more narrow than the armrests located between seats in order to maximize the use of space and accommodate high-percentile hip widths.

Conventional economy class seating arrangements typically include groups of adjacent, attached seats separated by armrests. Armrests in such seating groups typically have an equal width (e.g., about 5 cm) in all positions, unless different widths are necessitated by the installation of large structures such as tray tables or video monitors. Such uniformity has been favored for reasons such as the manufacturing cost advantages of employing common parts in all positions, the maintenance cost advantage of stocking fewer different spare parts, and the comfort advantage derived from better arm support of the wider armrests at the aisle and sidewall.

As will be explained in detail for each position, no comfort disadvantage has historically resulted from the reduced distance between armrests resulting from the use of wider armrests at the aisle and sidewall because human shoulder breadths have been accepted to be sufficiently greater than human hip breadths and, as a result, shoulder contact rather than hip contact has historically been the limiting factor for seats adjacent sidewalls and aisles in designing comfortable economy class seating.

The difference between shoulder and hip breadths in the population remains great enough that shoulder-to-shoulder contact results in the typical approximately 5 cm wide armrests of the prior art not compromising hip placement when installed between passengers. The greater width of typical current armrests, when installed between passengers, does provide a clear benefit as two passengers endeavor to share them. As a result, the present invention favors the continued use of the typical 5 cm armrest between passengers.

Historical shoulder and hip breadth data employed in the following discussion of prior art FIGS. 2 and 3 is typical of the data available to those skilled in the art. It is not known, however, whether the prior art originated from a diligent analysis of such anthropometric data or, rather, resulted from the observation in practice that shoulder contact with the sidewall and maintaining aisle clearance at the shoulder, rather than hip-armrest contact, limited the comfortable seating of passengers. This leads us to believe that the universal embrace of the prior art has resulted from decades of observation of the success of the prior art in service rather than a diligent study of anthropometry.

No comfort disadvantage has historically resulted from the wider armrests adjacent sidewalls of the prior art because the shoulder breadth of passengers was sufficiently larger than the hip breadth of corresponding percentile passengers that shoulder-to-sidewall contact proved to be the factor limiting the comfortable seated position of passengers seated adjacent the sidewall. In practice, the difference between shoulder breadths and hip breadths has been augmented by the sloping sidewall common in commercial airplanes.

Referring to prior art FIG. 2, a scale drawing of a sidewall 11 and adjacent seat in a commonly encountered Boeing™ model 737 is shown. In the seating arrangement, a typical 5 cm wide armrest 12 is separated from the sidewall 11 by about a 2.5 cm gap as required by the airplane manufacturer to provide for assembly tolerances. A seat bottom cushion 13 is shown with schematic passenger torsos 14 thereon accurately indicating the shoulder breadth of the median U.S. adult male 16, the hip breadth of the median U.S. adult female 17, the shoulder breadth of the 95^{th} percentile U.S. adult male 18, and the hip breadth of the 95^{th} percentile U.S. adult female 19. The male shoulder breadths have been employed with the female hip breadths to present the most extreme case, since at equal percentiles male shoulder breadths are greater than female shoulder breadths while female hip breadths are greater than male hip breadths.

The dominant practice among those skilled in the art of seat design is to use the 95^{th} percentile male measures as the maximum case for all parameters. The torsos 14 in FIG. 2 are aligned so as to be upright and positioned with the shoulder touching the sidewall at reference number 21. As can be seen, a gap remains between the armrest 12 and both torsos when the torsos are so positioned. Given this gap between hip and armrest, no advantage would accrue from a narrower armrest to provide for more hip breadth, while the cost disadvantages of a non-common armrest would accrue as well as the disadvantage of the lesser arm support comfort of a narrower armrest.

Similarly, the difference between shoulder and hip breadths has been augmented for seats adjacent aisles by the requirement of the FAA and the certification authorities of other nations that about a 50 cm aisle be maintained above armrest level, while about a 45 cm wide aisle is common between armrests. The prior art is illustrated in FIG. 3 in which the edge of the 50 cm aisle required by certification authorities shown at reference numeral 22 is indicated as it would be when the required 50 cm aisle is centered on a typical 45 cm aisle, the edge of which is indicated at reference numeral 23. As in FIG. 2, schematic passenger torsos 14 accurately indicating the shoulder breadth of the median U.S. adult male 16, the hip breadth of the median U.S. adult female 17, the shoulder breadth of the 95^{th} percentile U.S. adult male 18 and the hip breadth of the 95^{th} percentile U.S. adult female 19, are shown. The torsos 14 in FIG. 3 are aligned so as to be upright and positioned with the shoulder touching the required aisle shown at reference numeral 24. As can be seen, a gap remains between the armrest 12 and both torsos 14 when the torsos are so positioned. Given this gap between hip and armrest, no advantage would accrue from a narrower armrest to provide for more hip breadth, while the cost disadvantages of a non-common armrest would accrue as well as the disadvantage of the lesser arm support comfort of a narrower armrest.

A critical trend is that high-percentile female hip widths have grown far more rapidly in recent decades than have high-percentile male shoulder breadths or median hip widths or shoulder breadths. The growth of these measures is illustrated in FIG. 4, based upon various references. As explained below, this new understanding, in opposition to the teaching of the prior art, reveals the value of using narrower armrests adjacent the sidewall and aisle to accommodate high-percentile hip widths.

Prior art FIG. 5 illustrates the arrangement of passenger torsos 31 accurately indicating shoulder breadth and hip breadth measures from the year 2000. The shoulder breadth of the median U.S. adult male is shown at reference numeral 22, the hip breadth of the median U.S. adult female is shown at reference numeral 33, the shoulder breadth of the 95^{th} percentile U.S. adult male is shown at reference numeral 34, and the hip breadth of the 95^{th} percentile U.S. adult female is shown at reference numeral 36. The torsos 31 in FIG. 5 are aligned so as to be upright and positioned with the shoulder touching the sidewall at reference numeral 21. As can be seen when the torsos 31 are so positioned, while a gap remains between the armrest 12 and the median hip width 33, there is insufficient space to accommodate the hip breadth of the 95^{th} percentile U.S. adult female 36. If, as could be projected, the differential growth of hip and shoulder breadths illustrated in FIG. 4 continued after the year 2000, the inadequacy of hip space under the prior art for individuals with high-percentile hips has grown more acute.

Similarly, for seats adjacent an aisle, prior art FIG. 6 illustrates the seating arrangement with schematic passenger torsos 31 accurately indicating shoulder breadth and hip breadth measures from the year 2000. The torsos 31 in FIG. 6 are aligned so as to be upright and positioned with the shoulder touching the aisle at reference numeral 24. As can be seen when the torsos are so positioned, while a gap remains between the armrest 12 and the median hip width 33, there is insufficient space to accommodate the hip breadth of the 95^{th} percentile U.S. adult female 36. As indicated above for seats adjacent sidewalls, if the differential growth of hip and shoulder breadth illustrated in FIG. 4 continued after the year 2000, the inadequacy of hip space under the prior art for individuals with high-percentile hips has grown more acute.

Accordingly, based upon the trend that high-percentile hip widths have increased over time, what is needed is a seating arrangement for accommodating such high-percentile hip widths. A desirable seating arrangement would provide a cost effective way to adapt older seat designs in current aircraft to current and future passengers.

### BRIEF SUMMARY OF THE INVENTION

In one aspect, an aircraft passenger seating arrangement for accommodating high-percentile hip widths is provided herein.

In another aspect, a passenger seating arrangement for accommodating high-percentile adult male shoulder breadth and adult female hip breadth is provided herein.

In a further aspect, the seating arrangement maximizes passenger hip space while meeting aisle width requirements.

In a further aspect, the seating arrangement includes a group of adjacent seats positioned between the aisle and a sidewall or between aisles.

In a further aspect, the seats are attached.

In a further aspect, the seating group includes an armrest adjacent the aisle and the sidewall and armrests between adjacent seats.

In a further aspect, the armrests adjacent the aisle and the sidewall are narrower than the armrests between adjacent seats.

In a further aspect, the armrests between adjacent seats are about 5 cm wide and the armrests adjacent the aisle and sidewall are less than 5 cm wide.

In a further aspect, the armrests between adjacent seats are about 5 cm (i.e., 2 inches) wide and the armrests adjacent the aisle and sidewall are about 3.8 cm (i.e., 1.5 inches) wide.

To achieve the foregoing and other aspects and advantages, provided herein is an aircraft passenger seating arrangement for accommodating high-percentile hip widths including a seating unit including a plurality of adjacent, side-by-side seats, and a plurality of armrests including end armrests positioned at opposing ends of the seating unit and middle armrests positioned between adjacent seats, wherein the end armrests are narrower than the middle armrests to maximize available hip space.

In a further embodiment, each middle armrest may be about 5 cm wide and each end armrest may be about 3.8 cm wide.

In a further embodiment, the end armrests may be about 25% narrower than the middle armrests.

In a further embodiment, each seat may include a separate seatback and seat bottom, each of the plurality of armrests may be planar in form and parallel to their underlying seat bottom, and each of the plurality of armrests may be vertically spaced above their underlying seat bottom.

In a further embodiment, the seating unit may be positioned between an aisle and a sidewall of an aircraft and arranged transversely relative to a longitudinal axis of the aircraft, and the end armrest adjacent the sidewall may be spaced apart from the sidewall less than 3.8 cm.

In a further embodiment, the seating unit may be positioned between aisles, and a distance between end armrests of adjacent seating units may be about 45 cm.

In a further embodiment, the seating unit may include three seats, two middle armrests and two end armrests.

In a further embodiment, the seating unit may include four seats, three middle armrests and two end armrests.

In another embodiment, provided herein is an aircraft seating arrangement for accommodating high-percentile hip widths including first and second spaced seating units arranged to form a row of seats with an aisle therebetween, each of the seating units including a plurality of adjacent, side-by-side seats and a plurality of armrests including end armrests positioned at opposing ends of the seating unit and middle armrests positioned between adjacent seats, wherein the end armrests are narrower than the middle armrests to maximize available hip space.

In a further embodiment, the first seating unit may be positioned between the aisle and a sidewall of an aircraft and the second seating unit may be positioned between the aisle and a second aisle, and wherein the first and second seating units are arranged transversely relative to a longitudinal axis of the aircraft, and wherein the end armrest of the first seating unit adjacent the sidewall may be spaced apart from the sidewall less than 3.8 cm.

In a further embodiment, a distance between end armrests of the first and second seating units of a common aisle may be about 45 cm.

In a further embodiment, the first seating unit may include three seats, two middle armrests and two end armrests, and the second seating unit may include four seats, three middle armrests and two end armrests.

Additional features, aspects and advantages of the invention will be set forth in the detailed description which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE DRAWINGS

These and other features, aspects and advantages of the present invention are better understood when the following detailed description of the invention is read with reference to the accompanying drawings, in which:

FIG. 1 is a schematic diagram illustrating a seating arrangement according to an embodiment of the invention including narrow aisle and sidewall armrests;

FIG. 2 is a prior art sidewall seating arrangement;

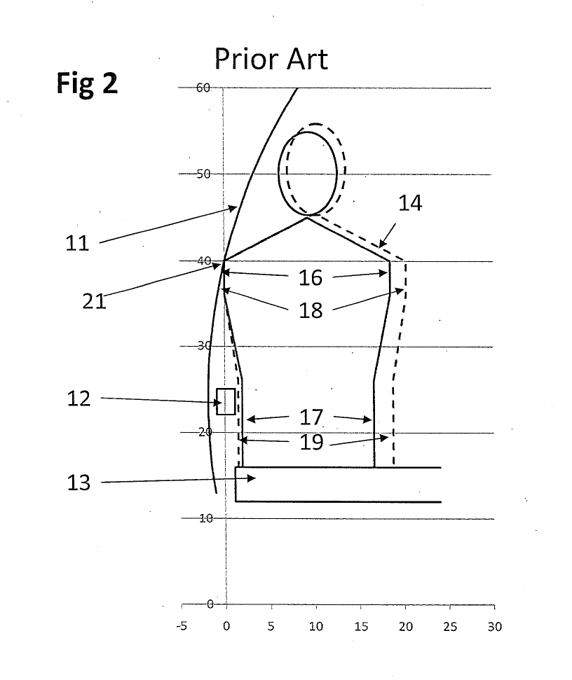

FIG. 3 is a prior art aisle seating arrangement;

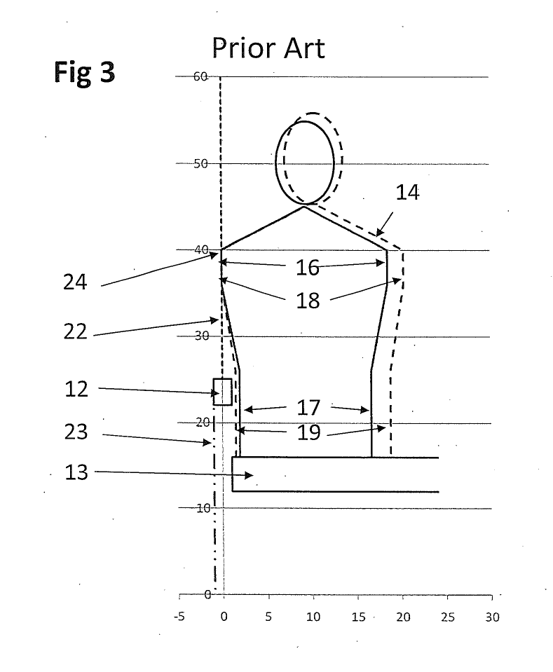

FIG. 4 is a graph showing the growth in U.S. hip and shoulder breadths over time;

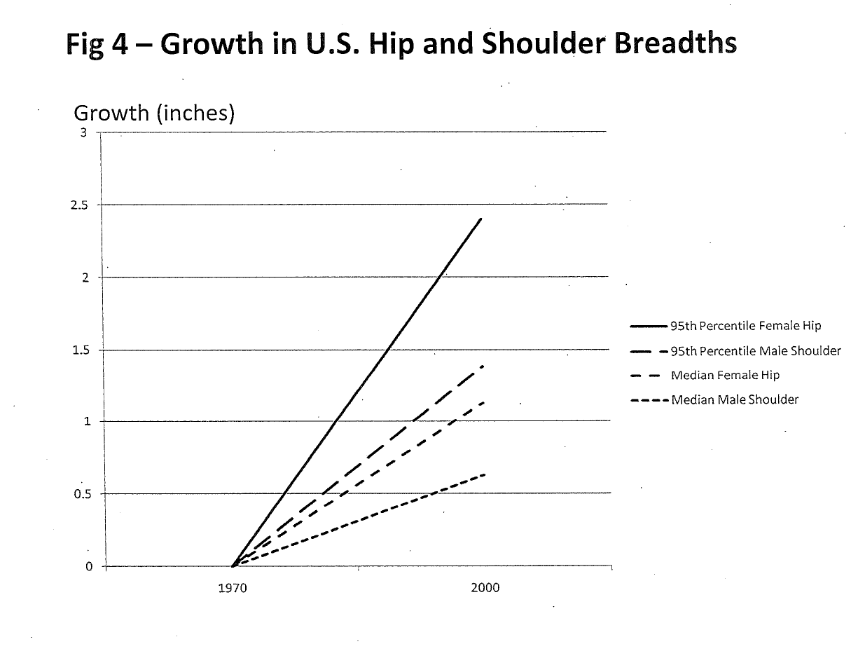

FIG. 5 is a prior art sidewall seating arrangement;

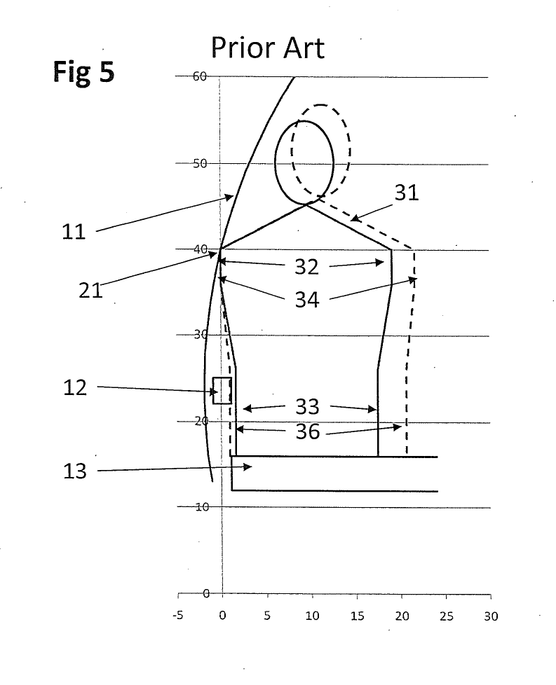

FIG. 6 is a prior art aisle seating arrangement;

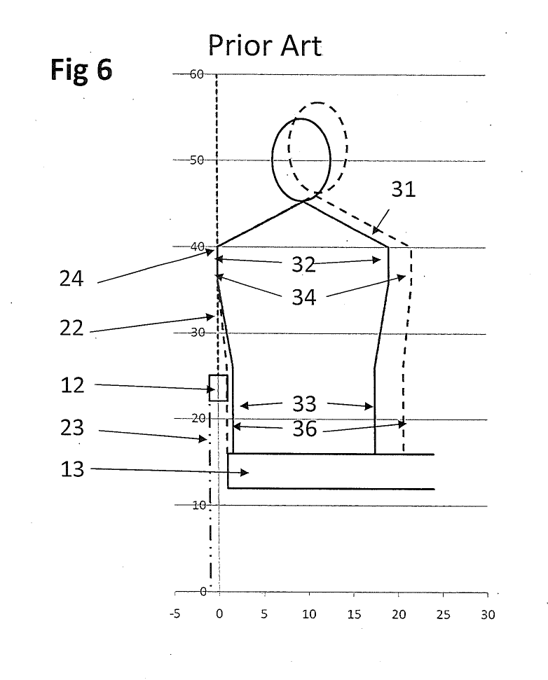

FIG. 7 is a sidewall seating arrangement according to an embodiment of the invention; and

FIG. 8 is an aisle seating arrangement according to an embodiment of the invention.

### DETAILED DESCRIPTION OF THE INVENTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Like reference numbers refer to like elements throughout the various drawings.

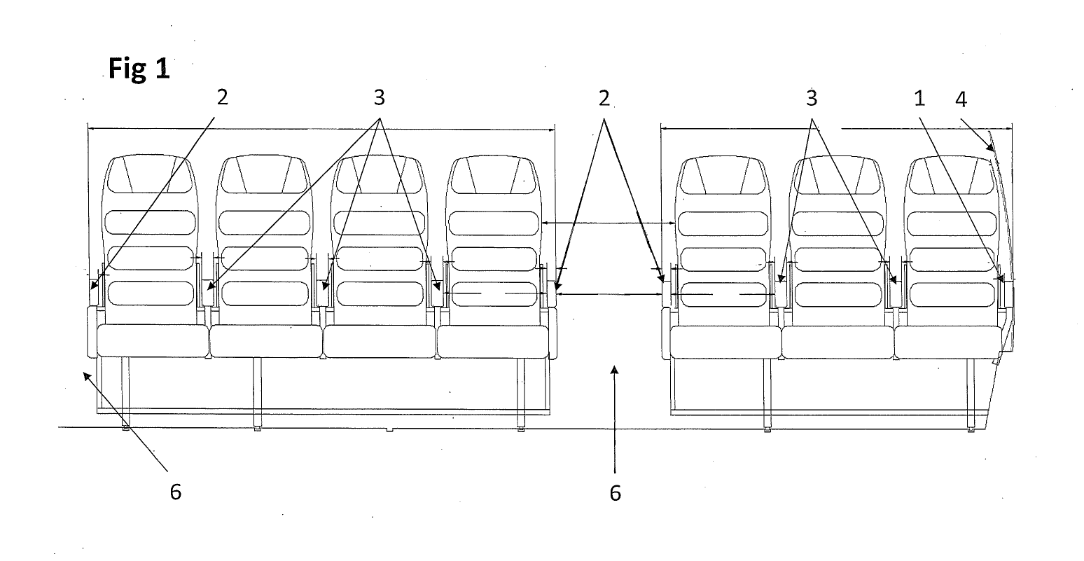

The present invention provides embodiments of economy- and tourist-class seating arrangements that employ armrests adjacent the aisle and/or sidewall that are narrower than the armrests installed between passenger seats, of seats in the same row. FIG. 1 illustrates one embodiment of a seating arrangement in which about 3.8 cm (i.e., about 1.5 inch) armrests are adjacent the sidewall and aisles, while about 5 cm (i.e., about 2 inch) armrests are employed between passengers/seats. The end armrest adjacent the sidewall is shown at reference number 1, the end armrests adjacent the aisle are shown at reference number 2, and the middle armrests between adjacent seats of the same group are shown at reference number 3.

The seating units or groups are represented in FIG. 1 as an outboard three-seat unit installed between the sidewall 4 and aisle 6, and a center four-seat unit located between two aisles 6. An additional outboard three-seat unit that could complete the row is not shown. The seating unit positioned between the sidewall 4 and aisle 6 is spaced from the sidewall 4 to satisfy the “not-to-exceed contour” required by the airplane manufacturer. For example, the upper end of the seatback may be spaced about 2 cm from the sidewall 4. In an exemplary embodiment, the aisle 6 may be about 50 cm wide, the distance between seatbacks on opposite sides of the aisle may be spaced about 56 cm apart, and the distance between aisle armrests 2 may be about 45 cm. In a further embodiment, the end armrests are about 25% narrower than the middle armrests.

It should be understood that seating unit configurations may vary and may include any number of adjacent, side-by-side seats with a corresponding greater number of armrests, for example a two-seat assembly with three armrests, a three-seat assembly with four armrests, a four-seat assembly with five armrests, etc. The seats may be standard airline seats include an adjustable seatback and seat pan or “bottom.” The armrest attachment configuration is not critical to the invention and may vary depending on seat type, frame design, etc. In an exemplary embodiment, individual seat width is no greater than about 50 cm. Seating units may be arranged in rows, for example, rows that extend generally transversely of the longitudinal axis of the aircraft, and rows being generally parallel with one another. Each armrest is generally planar and is generally parallel with the seat pan. A space is provided beneath each armrest.

The seating unit embodiments disclosed herein are particularly applicable to economy-class and tourist-class seating arrangements characterized in airline industry usage by having an overall width per passenger place that is less than commonly encountered shoulder widths (e.g., a 95th percentile male shoulder width of about 55 cm). Such limited widths make it difficult to reliably avoid physical contact between adjacent passengers, a fundamental differentiator between economy- and tourist-class seating and business- or first-class seating.

The seating arrangement embodiments disclosed herein are particularly well suited to seating units that do not have large amenities such as tray tables or video monitors incorporated into the armrests, since the installation of such amenities requires additional volume in the armrests driving armrest widths, in economy- or tourist-class seating, away from the comfort-driven optima accepted under the prior art.

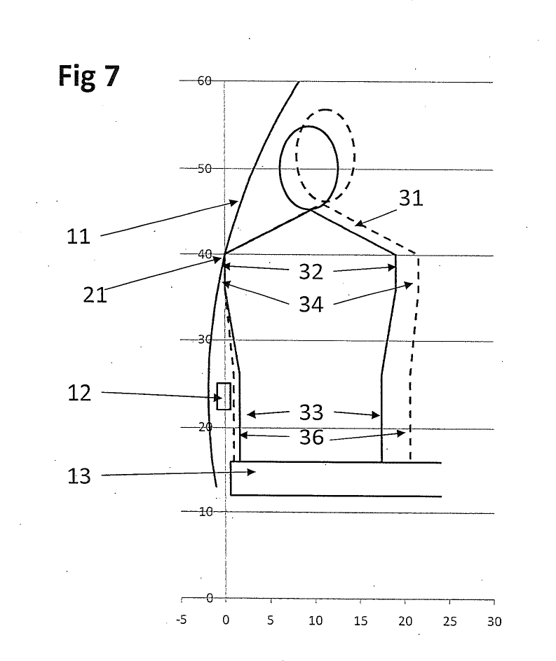

FIG. 7 illustrates an arrangement of the present invention with schematic passenger torsos 31, and with the narrower armrest of the present invention 12 positioned with the 2.5 cm gap between the armrest and sidewall 11 as required by the manufacturer. FIG. 7 accurately portrays shoulder breadth and hip breadth measures from the year 2000. The torsos 31 in FIG. 7 are aligned so as to be upright and positioned with the shoulder touching the sidewall as shown at reference numeral 21. As can be seen, when the torsos 31 are so positioned, a gap remains between the armrest 12 and both the median hip width 33, and the hip breadth of the 95^{th} percentile U.S. adult female 36. The gap indicates adequate space to accommodate passengers with high-percentile hip breadths.

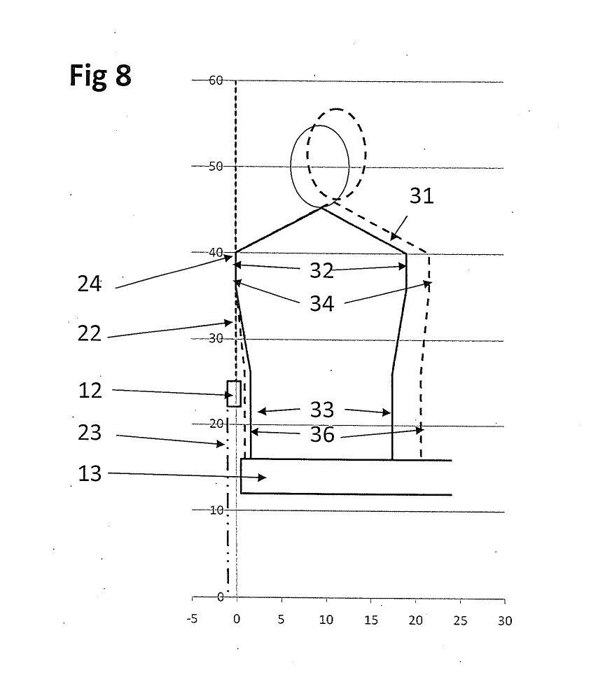

Similarly, for seats adjacent an aisle, FIG. 8 illustrates the arrangement of the present invention with schematic passenger torsos 31, accurately indicating shoulder breadth and hip breadth measures from the year 2000. The torsos 31 in FIG. 8 are aligned so as to be upright and positioned with the shoulder touching the aisle as shown at reference numeral 24. As can be seen, when the torsos 31 are so positioned, a gap remains between the armrest 12 and both the median hip width 33, and the hip breadth of the 95^{th} percentile U.S. adult female 36. The gap indicates adequate space to accommodate passengers with high-percentile hip breadths.

The foregoing description provides embodiments of the invention by way of example only. It is envisioned that other embodiments may perform similar functions and/or achieve similar results. Any and all such equivalent embodiments and examples are within the scope of the present invention and are intended to be covered by the appended claims.

What is claimed is:

1. An aircraft seating arrangement for accommodating high-percentile hip widths, comprising:
a seating unit including a plurality of adjacent, side-by-side seats; and
a plurality of armrests including end armrests positioned at opposing ends of the seating unit and middle armrests positioned between adjacent seats;
wherein the end armrests are narrower than the middle armrests to maximize available hip space.

2. The seating arrangement of claim 1, wherein each middle armrest is about 5 cm wide and each end armrest is about 3.8 cm wide.

3. The seating arrangement of claim 1, wherein the end armrests are about 25% narrower than the middle armrests.

4. The seating arrangement of claim 1, wherein each seat includes a seatback and a seat bottom, and wherein each of the plurality of armrests are planar in form and parallel to an underlying seat bottom.

5. The seating arrangement of claim 1, wherein each of the plurality of armrests is vertically spaced above an underlying seat bottom.

6. The seating arrangement of claim 1, wherein the seating unit is positioned between an aisle and a sidewall of an aircraft and arranged transversely relative to a longitudinal axis of the aircraft, and wherein the end armrest adjacent the sidewall is spaced apart from the sidewall less than 3.8 cm.

7. The seating arrangement of claim 1, wherein the seating unit is positioned between aisles in an aircraft, and wherein a distance between end armrests of adjacent seating units is about 45 cm.

8. The seating arrangement of claim 1, wherein the seating unit includes three seats, two middle armrests and two end armrests.

9. The seating arrangement of claim 1, wherein the seating unit includes four seats, three middle armrests and two end armrests.

10. An aircraft seating arrangement for accommodating high-percentile hip widths, comprising:
first and second spaced seating units arranged to form a row of seats with an aisle therebetween, each of the seating units including a plurality of adjacent, side-by-side seats and a plurality of armrests including end armrests positioned at opposing ends of the seating unit and middle armrests positioned between adjacent seats;
wherein the end armrests are narrower than the middle armrests to maximize available hip space.

11. The seating arrangement of claim 10, wherein each middle armrest is about 5 cm wide and each end armrest is about 3.8 cm wide.

12. The seating arrangement of claim 10, wherein the end armrests are about 25% narrower than the middle armrests.

13. The seating arrangement of claim 10, wherein each seat includes a seatback and a seat bottom, and wherein each of the plurality of armrests are planar in form and parallel to an underlying seat bottom.

14. The seating arrangement of claim 10, wherein each of the plurality of armrests are vertically spaced above an underlying seat bottom.

15. The seating arrangement of claim 10, wherein the first seating unit is positioned between the aisle and a sidewall of an aircraft and the second seating unit is positioned between the aisle and a second aisle, and wherein the first and second seating units are arranged transversely relative to a longitudinal axis of the aircraft, and wherein the end armrest of the first seating unit adjacent the sidewall is spaced apart from the sidewall less than 3.8 cm.

16. The seating arrangement of claim 10, wherein a distance between the end armrests of the first and second seating units of a common aisle is about 45 cm.

17. The seating arrangement of claim 10, wherein the first seating unit includes three seats, two middle armrests and two end armrests, and the second seating unit includes four seats, three middle armrests and two end armrests.
